(19) United States
(12) Patent Application Publication
(10) Pub. No.: US 2023/0122927 A1
(43) Pub. Date: Apr. 20, 2023

(54) SMALL OBJECT DETECTION METHOD AND APPARATUS, READABLE STORAGE MEDIUM, AND ELECTRONIC DEVICE

(71) Applicant: Chengdu Information Technology of CAS Co., Ltd., Sichuan (CN)

(72) Inventors: Xiaolin Qin, Sichuan (CN); Xin Lan, Sichuan (CN); Yongxiang GU, Sichuan (CN); Boyi Fu, Sichuan (CN); Yuncong Peng, Sichuan (CN); Dong Huang, Sichuan (CN)

(21) Appl. No.: 17/898,039

(22) Filed: Aug. 29, 2022

(30) Foreign Application Priority Data
Oct. 18, 2021 (CN) 202111211707.3

(51) Int. Cl. G06T 7/70; G06V 10/25; G06V 10/44; G06T 3/40; G06N 3/08

(52) U.S. Cl. CPC G06T 7/70; G06V 10/25; G06V 10/44; G06T 3/40; G06N 3/082; G06T 2207/20081; G06V 2201/07

(57) ABSTRACT

The present disclosure relates to a small object detection method and apparatus, a readable storage medium, and an electronic device. The method includes: inputting a to-be-detected image to a pre-trained small object detection model; and separately encoding and decoding information of the to-be-detected image in the small object detection model using a desubpixel convolution operation and a subpixel convolution operation running in pair: and extracting features in the to-be-detected image through the small object detection model, and outputting an object's category and location in the to-be-detected image. The present disclosure aims at solving the technical problem in the prior art that traditional FPNs fail to consider the correlation between the downsampling in the backbone network and the upsampling in the neck network during feature fusion, which leads to redundant operations and information loss. Moreover, far from bringing additional information, an interpolation algorithm adopted in the FPN method may put on the amount of calculation.

### TECHNICAL FIELD

The present disclosure relates to the field of object detection, and in particular to a small object detection method and apparatus, a readable storage medium, and an electronic device.

### BACKGROUND ART

With the rapid development of Deep Convolutional Neural Networks and GPU computing, object detection, as a foundation of many computer vision tasks, has been widely used and studied in the fields of medical treatment, transportation or security. At present, some excellent object detection algorithms have achieved good results in common datasets. Most of the current object detection algorithms are aimed at medium and large objects in natural scenarios, while small objects account for less pixels proportion, having the disadvantages of small coverage area, less information included and so on. Therefore, it is still an enormous challenge for small object detection.

One of the commonly used small object detection methods is multiscale feature fusion, a most typical model of which is Feature Pyramid Networks (FPNs). In a traditional FPN, firstly, a feature map is compressed on a channel, and then an interpolation algorithm is used to achieve spatial resolution mapping during feature fusion. However, traditional FPNs fail to take into account the correlation between the downsampling in the backbone network and the upsampling in the neck network during feature fusion, which leads to redundant operations and information loss. Moreover, the interpolation algorithm adopted in FPN may not only bring additional information, but increase the amount of calculation.

### SUMMARY

An objective of the present disclosure is to provide a small object detection method and apparatus, a readable storage medium, and an electronic device, so as to resolve the technical problem in the prior art that traditional FPNs fail to take into account the correlation between the downsampling in the backbone network and the upsampling in the neck network during feature fusion, which leads to redundant operations and inflammation loss. Moreover, an interpolation algorithm adopted in FPN not only brings additional information, but increase the amount of calculation.

To achieve the foregoing objective, a first aspect of the present disclosure provides a small object detection method, including:

inputting a to-be-detected image to a pre-trained small object detection model; and separately encoding and decoding information of the to-be-detected image in the small object detection model using a desubpixel convolution operation and a subpixel convolution operation running in pair: and

extracting features in the to-be-detected image through the small object detection model, and outputting an object's category and location in the to-be-detected image.

Optionally, a method for constructing the small object detection model includes:

constructing the small object detection model based on a YOLOv5s model, replacing all downsampling convolution layers in an object detection layer and subsequent detection layers in a backbone network of the YOLOv5s model with the desubpixel convolution operation, replacing all upsampling layers in a neck network of the YOLOv5s model with the subpixel convolution operation, and making the desubpixel convolution operation and the subpixel convolution operation appear in pair to obtain an improved YOLOv5s model: and

training the improved YOLOv5s model by using a training image set to obtain the small object detection model.

Optionally, the object detection layer is a C4 detection layer in the backbone network.

Optionally, said training the improved YOLOv5s model by using a training image set to obtain the small object detection model specifically includes:

dividing preprocessed images and labels in the training image set into a training set and a validation set:

optimizing parameters in the improved YOLOv5s model using the training set: and

selecting a group of parameters by the validation set with highest average accuracy as an optimized result to obtain the small object detection model.

Optionally, in the process of training the improved YOLOv5s model by using a training image set, the method further includes:

increasing the number of the images by randomly adopting one or more data enhancement methods of image cropping, image flipping, image scaling and histogram equalization.

Optionally, said extracting features in the to-be-detected image through the small object detection model, and outputting an object's category and location in the to-be-detected image specifically includes:

outputting feature detection boxes in the to-be-detected image through the small object detection model;

calculating a GIoU value of an overlapping part between adjacent feature detection boxes; and

if the adjacent feature detection boxes belong to a same category and the GIoU value is greater than or equal to a threshold, merging the adjacent feature detection boxes to obtain an object's category and location in the to-be-detected image.

A second aspect of the present disclosure provides a small object detection apparatus, including;

an input module configured to input a to-be-detected image to a pre-trained small object detection model; and separately encode and decode information of the to-be-detected image in the small object detection model using a desubpixel convolution operation and a subpixel convolution operation running in pair; and

a feature extraction module configured to extract features in the to-be-detected image through the small object detection model, and output an object's category and location in the to-be-detected image.

A third aspect of the present disclosure provides a non-transitory computer-readable storage medium, having a computer program stored therein, where the program is executed by a processor to perform steps of the method according to the first aspect.

A fourth aspect of the present disclosure provides an electronic device, including:

a memory having a computer program stored therein; and

a processor configured to execute the computer program in the memory to implement the steps of the method according to the first aspect.

According to the solution provided in embodiments of the present disclosure, a desubpixel convolution operation and a subpixel convolution operation running in pair are used in a pre-trained small object detection model, so that negative effects of the downsampling convolution and upsampling operation on small objects in traditional models are avoided. In addition, it further resolves the technical problem in the prior art that traditional FPNs fail to take into account the correlation between the downsampling in the backbone network and the upsampling in the neck network during feature fusion, which leads to redundant operations and information loss. Moreover, the use of the desubpixel convolution operation and a subpixel convolution operation running in pair makes it possible to effectively retain extracted feature information, and thus improve small object detection performance.

Other features and advantages of the present disclosure are described in detail in the following DETAILED DESCRIPTION part.

### BRIEF DESCRIPTION OF THE DRAWINGS

The accompanying drawings are provided for further understanding of the present disclosure, and constitute part of the specification. The accompanying drawings and the following specific implementations of the present disclosure are intended to explain the present disclosure, rather than to limit the present disclosure. In the accompanying, drawings:

FIG. 1 is a flowchart of a small object detection method according to an exemplary embodiment;

FIG. 2 is a schematic structural diagram of a YOLOv5s network in the prior art:

FIG. 3 is a schematic structural diagram of an improved YOLOv5s network according to an exemplary embodiment;

FIG. 4 is a block diagram of a small object detection apparatus according to an exemplary embodiment; and

FIG. 5 is a block diagram of an electronic device according to an exemplary embodiment.

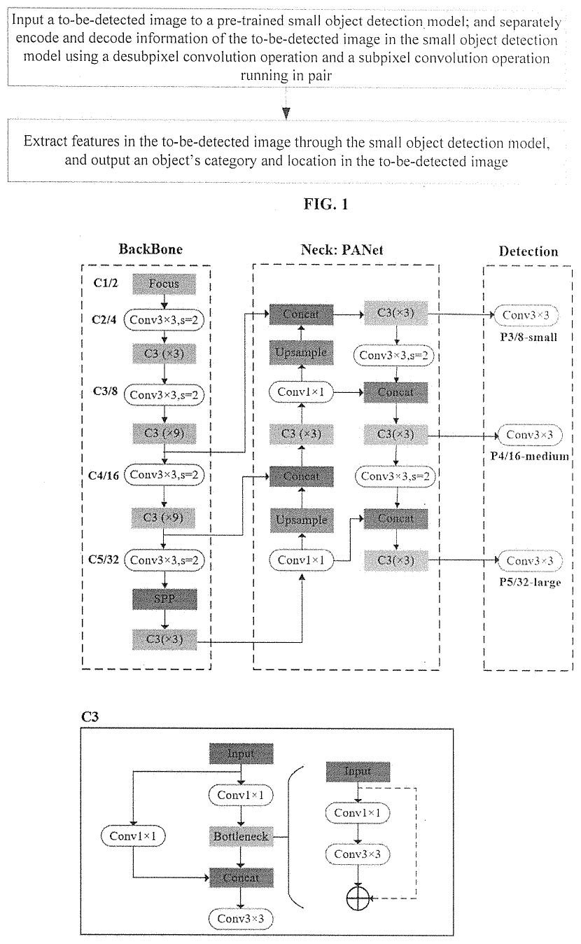

### DETAILED DESCRIPTION OF THE EMBODIMENTS

The embodiments of the present disclosure are described below with reference to the accompanying drawings. It should be understood that the specific embodiments described herein are merely intended to illustrate and explain the present disclosure rather than to limit the present disclosure.

Embodiments of the present disclosure provide a small object detection method. including the following steps.

Step 101, input a to-be-detected image to a pre-trained small object detection model: and separately encode and decode information of the to-be-detected image in the small object detection model using a desubpixel convolution operation and a subpixel convolution operation running in pair.

Step 102: extract features in the to-be-detected image through the small object detection model, and output an object's category and location in the to-be-detected image.

In the embodiments of the present disclosure, regarding a to-be-detected image. the process of converting spatial information into channel information is called encoding, which is characterized by decreased spatial resolution and increased channel dimension; and the process of converting channel information into spatial information is called decoding, which is characterized by decreased channel dimension and increased spatial resolution. The combination of decoding and encoding operations running in pair can reduce the difficulty of network decoding, and is more conducive to mining spatial orientation features. In the embodiments of the present disclosure, the desubpixel convolution operation and the subpixel convolution operation are combined for use in an object detection task, which can avoid the negative impact of downsampling convolution and upsampling operation on small objects, and effectively retain extracted feature information, so as to improve the performance of small object detection.

Next, a method for constructing a small object detection model in the embodiments of the present disclosure is described below. It should be noted that the construction method in the embodiments of the present disclosure is applicable to various neural network models. In the embodiments of the present disclosure, the yolov5s network is taken as an example for description.

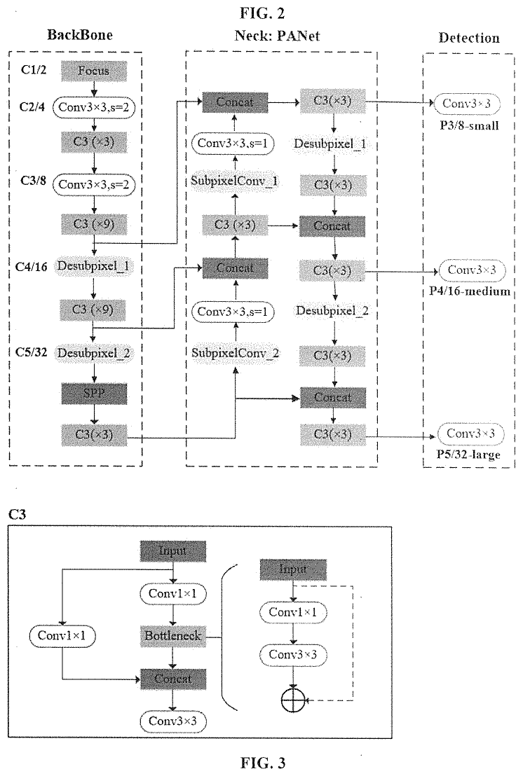

Now referring to FIG. 2 and FIG. 3. FIG. 2 is a schematic structural diagram of a YOLOv5s network in the prior art; and FIG. 3 is a schematic structural diagram of an improved YOLOv5s network according to an exemplary embodiment. In the encoding process of the YOLOv5s network (Version 5), all downsampling convolution layers of an object detection layer and subsequent detection layers are replaced with a desubpixel convolution operation, and all upsampling layers in the neck network in the decoding process are replaced with a subpixel convolution operation, so as to construct an improved YOLOv5s detection model for small objects. In the embodiments of the present disclosure, the desubpixel convolution operation and subpixel convolution operation are used in pair in the whole structure. As can be seen from FIG. 3, the object detection layer is C4 detection layer in backbone, and the desubpixel convolution operations and subpixel convolution operations used in pairs are Desubpixel-1 and SubpixelConv-1, and Desubpixel-2 and SubpixelConv-2, respectively.

According to a possible implementation, in the encoding process, the convolution operation in the C4 detection layer and subsequent detection layers with a kernel size of 3*3 and a stride of 2 can be replaced with the desubpixel convolution operation, so that the length and width of an image are reduced by ½, and the number of channels is doubled. The downsampling convolution operation may blur information, while desubpixel convolution would not cause the loss of information, the desubpixel convolution operation can be adopted to deal with information loss of small objects caused by downsampling operation thus. The number of channels refers to the channels in an image. For example, there are three channels R, G and B in an original image (such as a picture taken by a mobile phone), but after many convolution operations, the number of channels will change accordingly.

In the decoding process, an upsampling layer is replaced with a subpixel convolution layer, such that the length and width of an image are doubled, and the number of channels is reduced by ½, thus acquiring an image with a higher resolution.

After constructing the improved YOLOv5s detection model for small objects, original images are divided into a training set and a test set after preprocessing, and the training set is used for optimizing parameters including all the parameters in a neural network. In the training process, data enhancement methods are randomly selected, and then a validation set is used to select a group of parameters with the highest average accuracy as the optimized result. As a result, the optimized small object detection model is obtained.

According to a possible implementation, during training model, appropriate original images can be selected for training as required. In the embodiments of the present disclosure, a COCO 2017 dataset is taken as an example for description. The 2017 version of the dataset contains 118,287 training images and 5,000 validation images, with a total of 80 categories.

Then, the backbone network of YOLOv5s (that is, the backbone network as shown in FIG. 2 and FIG. 3) is pre-trained on the COCO dataset, and the weight of the network is updated by back propagation with cross-entropy loss as a loss function.

Next, part of the weight of the trained network is taken as the weight of the backbone network of improved YOLOv5s, and parameter optimization and parameter selection are conducted using the above datasets.

In the embodiments of the present disclosure, one or more of data enhancement methods of image cropping, image flipping, image scaling, or histogram equalization can be randomly used in the training process. This process can not only expand the amount of training data, but also enhance the randomness of the data, making it possible to obtain a small object detection model with stronger generalization performance.

In the embodiments of the present disclosure, classification loss can be calculated by cross entropy, the position loss can be calculated by a mean square error, and the confidence loss can be calculated by cross entropy, so as to guide parameter optimization. In the training process, the loss function is also optimized by adopting a Stochastic Gradient Descent, with an initial learning rate being 0.001, batch size being 64, and the maximum number of iterations being 300. It should be noted that the foregoing data are intended merely for illustration, rather than for limiting the technical solutions.

In the embodiments of the present disclosure, after a small object detection model is constructed, a to-be-detected image is input to the trained small object detection model for feature extraction.

In the embodiments of the present disclosure, during object detection, a feature detection box [x, y, w, h, probability] in the to-be-detected image is output through the small object detection model, where (x, y) denotes coordinates of the upper left corner of the detection box, w denotes the width of the detection box along X axis, h denotes the height of the detection box along Y axis, and probability denotes the classification probability.

Then non-maximum suppression operation is conducted on a predicted object, and Generalized Intersection over Union (GIoU) value of an overlapping part between adjacent feature detection boxes is calculated. If the adjacent feature detection boxes belong to the same category and the GIoU value is greater than a threshold, then the adjacent detection boxes are merged to obtain an object's category and location in the to-be-detected image. Whether adjacent feature detection boxes belong to the same category can be judged through a classification subnetwork; the threshold can be set to [0, 2], such as 0.7 or 1.1, which may be set by those skilled in the art according to actual needs.

It should be noted that the prediction object in the embodiments of the present disclosure may be a to-be-detected small object, or a medium and large object, which is not limited in the present disclosure.

The following group of experimental results give a comparison between the small object detection model and YOLOv5s in the embodiments of the present disclosure. According to the present disclosure, confirmation experiment is conducted by yolov5s for the COCO dataset. Experimental results are shown in the following table.

| model | size | mAP | AP_{0.5} | AP_{0.75} | AP_{S} | AP_{M} | AP_{L} | params | FLOP_{S} |
|---|---|---|---|---|---|---|---|---|---|
| YOLOv5s | 640 | 0.368 | 0.555 | 0.402 | 0.209 | 0.423 | 0.470 | 7.3 | 17.0 |
| Present | 640 | 0.376 | 0.558 | 0.410 | 0.216 | 0.424 | 0.492 | 7.0 | 17.2 |
| disclosure | | | | | | | | | |

Size represents image resolution, params represents the number of parameters (in Million), FLOPs represents the amount of computation for floating-point numbers (in Billion), and precision P represents the proportion of the true positives (True Positive, TP) in instances predicted to be positive.

$$P = \frac{TP}{TP + FP} = \frac{TP}{all detections}$$

APc represents the ratio of the sum of the precision P₁ of each instance of category C to the total number Nc of instances of category C. Mean Average Precision (mean AP) denotes an average value of AP, which is used for measuring the training effect of the model regarding each category.

$${AP}_{c} = \frac{{\sum }_{i = 1}^{{N}_{c}} {P}_{i}}{{N}_{c}}$$

$$mean AP = \frac{{\sum }_{c = 1}^{t} {AP}_{c}}{C}$$

mean AP@0.5 represents the mean value of AP when the Intersection over Union (IOU) is 0.5; mean AP@0.5:0.95 represents the mean value of AP when IOU is taken from 0.5 to 0.95 with an interval of 0.05, which can better reflect the precision of the model than AP@0.5. P and R are counted when the IOU threshold is 0.5. The mAP@0.5 is denoted as AP_{0.5}, mAP@0.75 is denoted as AP₀₇₅, and mAP@0.5:0.95 is denoted as mAP. AP_{S}, AP_{M}, and AP₁, denote mean AP of a small object, a medium object and a .large object under an IOU of 0.5, respectively.

Based on the same inventive concept, the embodiments of the present disclosure further provide a small object detection apparatus 400. As shown in FIG. 4, the small object detection apparatus includes: an input module 401 configured to input a to-be-detected image to a pre-trained small object detection model; and separately encode and decode information of the to-be-detected image in the small object detection model using a desubpixel convolution operation and a subpixel convolution operation running in pair; and a feature extraction module 402 configured to extract features in the to-be-detected image through the small object detection model, and output an object's category and location in the to-be-detected image.

Specific manners of operations performed by the modules in the apparatus in the foregoing embodiment have been described in detail in the embodiments of the related method, and details are not described herein again.

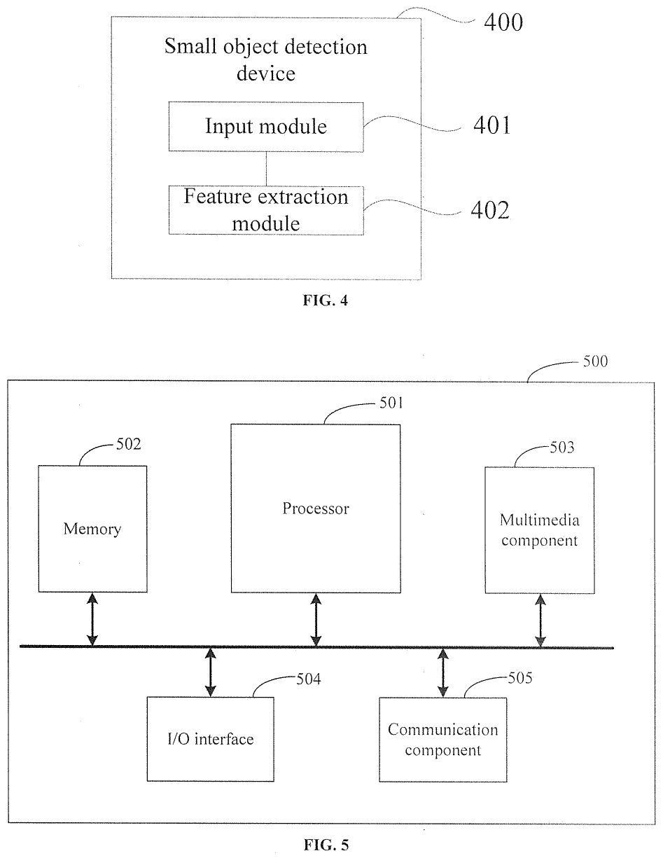

FIG. 5 is a block diagram of an electronic device 500 according to an exemplary embodiment. As shown in FIG. 5, the electronic device 500 may include a processor 501 and a memory 502. The electronic device 500 may also include one or more of a multimedia component 503, an input/output (I/O) interface 504, and a communication component 505.

The processor 501 is configured to control an overall operation of the electronic device 500 to complete all or a part of the steps of the above small object detection method. The memory 502 is configured to store various types of data to support an operation on the electronic device 500. The data may include, for example, an instruction of any application program or method for performing an operation on the electronic device 500, as well as data related to the application program, such as contact data, received and transmitted messages, pictures, audios, and videos. The memory 502 may be realized by any type of volatile or nonvolatile storage device or their combination, such as a static random access memory (SRAM). an electrically erasable programmable read-only memory (EEPROM), all erasable programmable read-only memory (EPROM), a programmable read-only memory (PROM), a read-only memory (ROM), a magnetic memory, a flash memory, a magnetic disk, or an optical disk. The multimedia component 503 may include a screen and an audio component. The screen may be a touch screen, and the audio component is configured to output and/or input audio signals. For example, the audio component may include a microphone configured to receive external audio signals. The received audio signals may be further stored in the memory 502 or sent via the communication component 505. The audio component further includes at least one speaker for outputting audio signals. The I/O interface 504 provides an interface between the processor 501 and other interface module, and the foregoing interface module may he a keyboard, a mouse, a button, etc. The button may be a virtual button or a physical button. The communication component 505 is used for achieving wired or wireless communication between the electronic device 500 and another device. Wireless communications include Bluetooth, Near Field Communication (NFC), 2G, 3G, 4G. NB-IOT, eMTC, or other 5G, or a combination of one or more of the above, which are not limited herein. Therefore, the corresponding communication component 505 may include a Wi-Fi module, a Bluetooth module, an NFC module, etc.

In an exemplary embodiment, the electronic device 500 may be realized by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components, and is configured to execute the foregoing small object detection method.

In another exemplary embodiment, a computer-readable storage medium including a program instruction is also provided. The program instruction is executed by a processor to implement steps of the foregoing small object detection method. For example, the computer-readable storage medium may be the above memory 502 including a program instruction. The program instruction may be executed by a processor 501 of an electronic device 500 to complete the foregoing small object detection method.

In another exemplary embodiment, a computer program product is further provided, including a computer program executable by a programmable device, the computer program having a encoding portion for implementing the foregoing, small object detection method when executed by the programmable device.

Preferred implementations of the present disclosure are described above in detail with reference to the accompanying drawings, but the present disclosure is not limited to specific details in the above implementations. A plurality of simple variations can be made to the technical solutions of the present disclosure without departing from the technical ideas of the present disclosure, and these simple variations fall within the protection scope of the present disclosure.

In addition, it should be noted that various specific technical features described in the foregoing embodiments can be combined in any suitable manner, provided that there is no contradiction. To avoid unnecessary repetition, various possible combination modes of the present disclosure are not described separately.

In addition, various embodiments of the present disclosure can be combined in any and any combined embodiment should also be regarded as the content disclosed in the present disclosure, as long as it does not violate the idea of the present disclosure.

What is claimed is:

1. A small object detection method, comprising:
inputting a to-be-detected image to a pre-trained small object detection model; and separately encoding and decoding information of the to-be-detected image in the small object detection model using a desubpixel convolution operation and a subpixel convolution operation running in pair; and
extracting features in the to-be-detected image through the small object detection model, and outputting an object's category and location in the to-be-detected image.

2. The method according to claim 1, wherein a method for constructing the small object detection model comprises:
constructing the small object detection model based on a YOLOv5s model, replacing all downsampling convolution layers in an object detection layer and subsequent detection layers in a backbone network of the YOLOv5s model with the desubpixel convolution operation, replacing all upsampling layers in a neck network of the YOLOv5s model with the subpixel convolution operation, and making the desubpixel convolution operation and the subpixel convolution operation appear in pair to obtain an improved YOLOv5s model; and
training the improved YOLOv5s model by using a training image set to obtain the small object detection model.

3. The method according to claim 2, wherein the object detection layer is a C4 detection layer in the backbone network.

4. The method according to claim 2, wherein said training the improved YOLOv5s model by using a training image set to obtain the small object detection model specifically comprises:
dividing preprocessed images and labels in the training image set into a training set and a validation set;
optimizing parameters in the improved YOLOv5s model using the training set: and
selecting a group of parameters by the validation set with highest average accuracy as an optimized result to obtain the small object detection model.

5. The method according to claim 4, wherein in the process of training the improved YOLOv5s model by using a training image set, the method further comprises:
increasing the number of the images by randomly adopting one or more of data enhancement methods of image cropping, image flipping, image scaling and histogram equalization.

6. The method according to claim 1, wherein said extracting features in the to-be-detected image through the small object detection model, and outputting an object's category and location in the to-be-detected image specifically comprises:
outputting feature detection boxes in the to-be-detected image through the small object detection model;
calculating a GIoU value of an overlapping part between adjacent feature detection boxes: and
if the adjacent feature detection boxes belong to a same category and the GIoU value is greater than or equal to a threshold, merging the adjacent feature detection boxes to obtain an object's category and location in the to-be-detected image.

7. A small object detection apparatus, comprising:
an input module configured to input a to-be-detected image to a pre-trained small object detection model; and separately encode and decode information of the to-be-detected image in the small object detection model using a desubpixel convolution operation and a subpixel convolution operation running in pair; and
a feature extraction module configured to extract features in the to-be-detected image through the small object detection model, and output an object's category and location in the to-be-detected image.

8. A non-transitory computer-readable storage medium, having a computer program stored therein, wherein the program is executed by a processor to perform steps of the method according to any one of claims 1-6.

9. An electronic device, comprising:
a memory having a computer program stored therein; and
a processor configured to execute the computer program in the memory to implement the steps of the method according to the any one of claims 1-6.
